(19) United States
(12) Patent Application Publication
(10) Pub. No.: US 2018/0060311 A1
(43) Pub. Date: Mar. 1, 2018

(54) MULTI-LANGUAGE TRANSLATION CONVERTER

(71) Applicant: Takyla Robinson, Chicago, IL (US)

(72) Inventor: Takyla Robinson, Chicago, IL (US)

(21) Appl. No.: 15/693,041

(22) Filed: Aug. 31, 2017

Related U.S. Application Data
(60) Provisional application No. 62/382,620, filed on Sep. 1, 2016.

(51) Int. Cl. G06F 17/28; G06F 3/16; G06F 3/041; G10L 15/26; G10L 15/22

(52) U.S. Cl. CPC G06F 17/2836; G06F 3/165; G10L 15/22; G10L 15/265; G06F 3/0412

(57) ABSTRACT

A multi-language translation converter comprising: a main body including a plurality of walls forming an interior volume and a front surface; at least one microphone member; at least one speaker member; at least one computer circuit board; and multi-language translation software. The multi-language translation software is encoded upon the at least one computer circuit board and is adapted to decipher language retrieved by the at least one microphone member and provide a translation in a pre-chosen language through text upon the liquid crystal display screen and audio through the at least one speaker member.

### CROSS-REFERENCE TO RELATED APPLICATION

The present application is related to and claims priority from prior provisional application Ser. No. 62/382,620, filed Sep. 1, 2016 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of mobile device useful for translating languages and more specifically relates to a multi-language translation converter structured and arranged to interpret words, phrases, or conversations in virtually any foreign language, then offering a verbal translation in the language of the user's choice both audibly and visibly to provide a technologically advanced means of breaking down language barriers, via the simple touch of a button.

### 2. Description of the Related Art

Translation is the communication of the meaning of a source-language text by means of an equivalent target-language text. While interpreting—the facilitating of oral or sign-language communication between users of different languages—antedates writing, translation began only after the appearance of written literature. Translators always risk inappropriate spill-over of source-language idiom and usage into the target-language translation. On the other hand, spill-overs have imported useful source-language calques and loanwords that have enriched the target languages. Indeed, translators have helped substantially to shape the languages into which they have

Various attempts have been made to solve problems found in mobile device useful for translating languages art. Among these are found in: U.S. Publication No. 2010/0030549 to Michael M. Lee; U.S. Publication No. 2013/0282359 to Yu Jin Kim, Won Ho Shin; and U.S. Pat. No. 8,527,280 to Peter V. Boesen. This prior art is representative of mobile device useful for translating languages.

Ideally, a multi-language translation converter should be user-friendly and safe in-use and, yet should operate reliably and be manufactured at a modest expense. Thus, a need exists for a multi-language translation converter structured and arranged to interpret words, phrases, or conversations in virtually any foreign language, then offering a verbal translation in the language of the user's choice both audibly and visibly to provide a technologically advanced means of breaking down language barriers, via the simple touch of a button and to avoid the above-mentioned problems

### BRIEF SUMMARY OF THE INVENTION

In view of the foregoing disadvantages inherent in the known mobile device useful for translating languages art, the present invention provides a cosmetic device. The general purpose of the present invention, which will be described subsequently in greater detail is to provide a for a mobile device useful for translating languages and more specifically relates to a multi-language translation converter structured and arranged to interpret words, phrases, or conversations in virtually any foreign language, then offering a verbal translation in the language of the user's choice both audibly and visibly to provide a technologically advanced means of breaking down language barriers, via the simple touch of a button.

A multi-language translation converter comprising: a main body including a plurality of walls forming an interior volume and a front surface; at least one microphone member; at least one speaker member; at least one computer circuit board; and multi-language translation software. The front surface is located on one of the plurality of walls and includes a liquid crystal display screen. The at least one microphone member is attached to the main body and is adapted to retrieve external audio sounds and convert them into electronic signals.

The at least one speaker member is attached to the main body and is adapted to convert electronic signals into audio sounds and project them externally. The at least one computer circuit board is located within the interior volume of the main body and is electronically connected to the microphone member and the speaker member. The multi-language translation software is encoded upon the at least one computer circuit board and is adapted to decipher language retrieved by the at least one microphone member and provide a translation in a pre-chosen language through text upon the liquid crystal display screen and audio through the at least one speaker member.

The present invention holds significant improvements and serves as a Multi-Language Translation Converter. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, Multi-Language Translation Converter, constructed and operative according to the teachings of the present invention.

FIG. 1 shows a perspective view illustrating a Multi-Language Translation Converter according to an embodiment of the present invention.

FIG. 2A is a perspective view illustrating another view of power source is formed as a rechargeable battery member of the Multi-Language Translation Converter according to an embodiment of the present invention.

FIG. 2B is a perspective view illustrating another view of power source is formed as an alternating current wire and plug having a transformer member of the Multi-Language Translation Converter according to an embodiment of the present invention.

FIG. 3 is a perspective view illustrating the Multi-Language Translation Converter in an in-use condition according to an embodiment of the present invention of FIG. 1.

The various embodiments of the present invention will hereinafter be described in conjunction with the appended drawings, wherein like designations denote like elements.

### DETAILED DESCRIPTION

As discussed above, embodiments of the present invention relate to mobile device useful for translating languages and more specifically relates to a multi-language translation converter structured and arranged to interpret words, phrases, or conversations in virtually any foreign language, then offering a verbal translation in the language of the user's choice both audibly and visibly to provide a technologically advanced means of breaking down language barriers, via the simple touch of a button.

Generally speaking, the Multi-Language Translation Converter comprising a novel product offering consumers a practical solution to the aforementioned challenges. As the name implies, the Multi-Language Translation Converter comprises a specially designed compact, handheld, unit, essentially rectangular in shape. Encased in a durable plastic housing offered in attractive, stately colors, this device would essentially resemble a tablet or smartphone.

Powered by a rechargeable battery source with a handy side port for charging via an AC plug, this product would contain a bevy of other convenient external features. The top of the unit's open front panel would offer a liquid display screen (LCD) with touch capabilities to facilitate visual accessibility of the system's menu options. This screen would also display the translated words into readable text. The Multi Language Translation Converter could conceivably be capable of translating dozens of languages. Small speakers would be located on the top and the bottom of the unit; additionally, a handy On/Off switch and language selector button would also be provided.

As for the Multi Language Translation Converter's internal operation capabilities, the unit could contain a sound amplifier, automatically adjusting to catch any words spoken into the Multi Language Translation Converter and emitting the verbal translations at a chosen volume. Not only would the Multi Language Translation Converter translate text, it would also interpret vocalizations. As such, this product would allow a user to select any chosen language heard, or let the device decipher the language, and then provide the English (or other chosen language) translation through text and sound. The product would work in reverse, converting English, for example, to another selected language.

The Multi Language Translation Converter would provide consumers with a handy translation tool to be utilized when conversing with virtually anyone who speaks or writes another language. Whether one is listening to a business presentation in Chinese, hearing the specials or reading the menu in a fancy French restaurant, or conversing with a hospital patient who doesn't speak the same language, this product would provide the user with the tools necessary to translate the other participant's words, and even translate their own words to the other participant, so both parties are understood. Providing consumers across the globe with a simplified yet technologically advanced means of communicating, the Multi Language Translation Converter could prove an invaluable commodity to anyone who regularly or on occasion has the opportunity to converse with those from different countries or who speak different languages.

Ideal for use by those who travel internationally or conduct businesses with others overseas, this product could also prove useful for daily use, providing a handy translation tool with which to translate spoken dialogue swiftly and efficiently, shattering language barriers with just the simple pressing of a button. The Multi Language Translation Converter could prove particularly useful in the medical community, bridging the language gap so that patients and caregivers are better able to convey problems and diagnoses, improving care exponentially. As such, the Multi Language Translation Converter should be extremely well received.

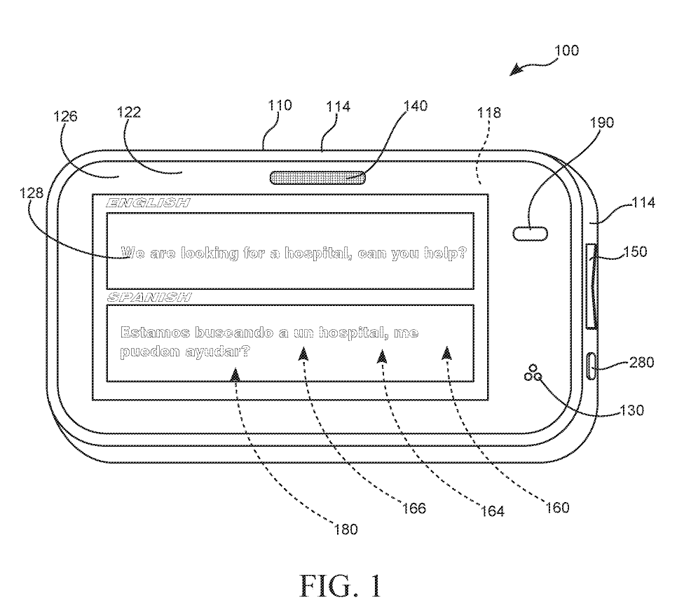

Referring now to FIGS. 1-3, showing perspective views illustrating multi-language translation converter 100 according to an embodiment of the present invention of FIG. 1.

Multi-language translation converter 100 comprising: main body 110 including a plurality of walls 114 forming interior volume 118 and front surface 122; at least one microphone member 130; at least one speaker member 140; at least one computer circuit board 160; and multi-language translation software 180. Wherein plurality of walls 114 of main body 110 are formed from a rigid plastic material. Front surface 122 is located on one of plurality of walls 114 and includes liquid crystal display screen 126. At least one microphone member 130 is attached to main body 110 and is adapted to retrieve external audio sounds and convert them into electronic signals. Wherein there are two spaced microphone members 130.

At least one speaker member 140 is attached to main body 110 and is adapted to convert electronic signals into audio sounds and project them externally. Wherein there are two spaced speaker members 140. Multi-language translation converter 140 further comprises volume adjustment potentiometer 150 attached to main body 110 and is adapted to adjust the volume of sound from speaker member 140.

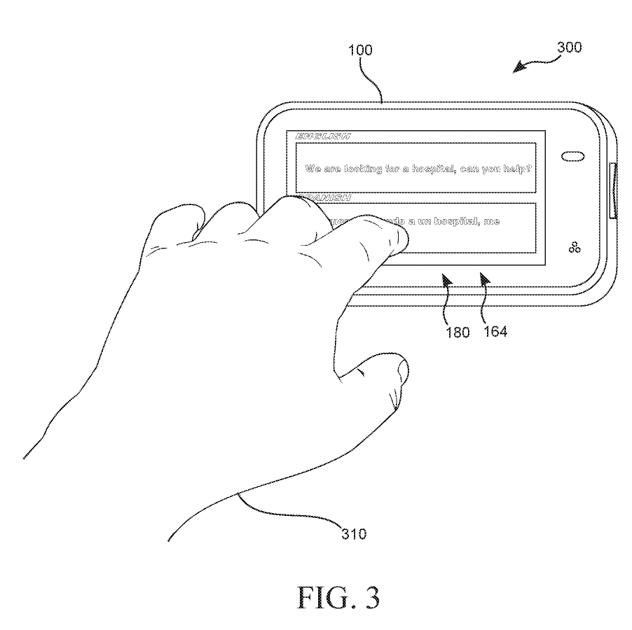

Multi-language translation converter 100 further comprises language selector button 190 attached to main body 110 and is electronically connected to at least one microphone member 130, at least one speaker member 140, and at least one computer circuit board 160, and is adapted to allow user 310 to choose language multi-language translation software 180 will translate that is retrieved by at least one speaker member 140 as shown in in-use condition 300 of FIG. 3.

At least one computer circuit board 160 is located within interior volume 118 of main body 110 and is electronically connected to microphone member 130 and speaker member 140. Multi-language translation software 180 is encoded upon at least one computer circuit board 160 and is adapted to decipher language retrieved by at least one microphone member 130 and provide a translation in a pre-chosen language through text upon liquid crystal display screen 126 and audio through at least one speaker member 140.

At least one computer circuit board 160 further comprises software 164 encoded thereon adapted to provide menu options 166 upon liquid crystal display screen 126 for allowing user 310 to choose a specific language to translate to emit upon liquid crystal display screen 126 and through at least one speaker member 140. Liquid crystal display screen 126 includes touch-screen technology 128.

Multi-language translation software 180 is adapted allow user 310 to determine a desired decibel level audio from at least one speaker member 140 is emitted therefrom and then automatically control the volume of the audio emitted therefrom. Multi-language translation software 180 is adapted to provide text upon liquid crystal display screen 126 that includes information on the language detected and the language translated into.

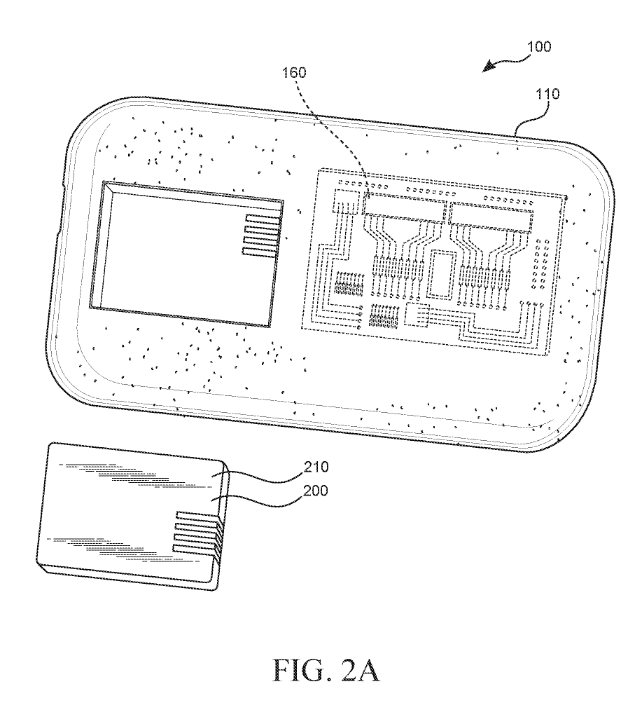

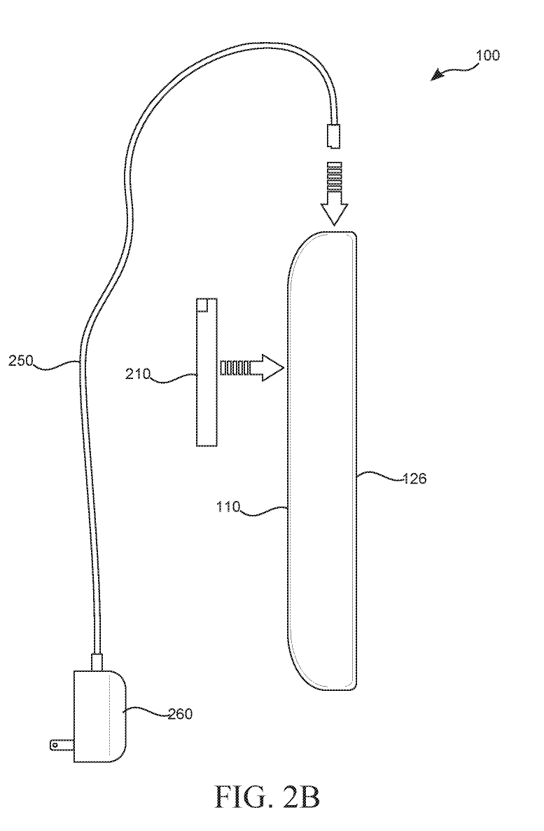

Multi-language translation converter 100 further comprises power source 200 located within the interior volume 118 of main body 110 and is electronically connected to at least one microphone member 130, at least one speaker member 140, and at least one computer circuit board 160, and provides power thereto. Power source 200 may be formed as rechargeable battery member 210 as shown in FIG. 2A. Power source 200 may alternatively be formed as alternating current wire and plug 250 having transformer member 260 electrically connected thereto and adapted to retrieve power from an external source and transform and provide pre-determined electrical power to at least one microphone member 130, at least one speaker member 140, and at least one computer circuit board 160 as shown in FIG. 2B. Multi-language translation converter 100 further comprises on/off switch 280 attached to main body 110 and is adapted to turn on and off power from power source 200.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A multi-language translation converter comprising:
a main body including:
a plurality of walls forming an interior volume; and
a front surface;
wherein said front surface is located on one of said plurality of walls and includes a liquid crystal display screen;
at least one microphone member;
wherein said at least one microphone member is attached to said main body and is adapted to retrieve external audio sounds and convert them into electronic signals;
at least one speaker member;
wherein said at least one speaker member is attached to said main body and is adapted to convert electronic signals into audio sounds and project them externally;
at least one computer circuit board;
wherein said at least one computer circuit board is located within said interior volume of said main body and is electronically connected to said microphone member and said speaker member; and
multi-language translation software;
wherein said multi-language translation software is encoded upon said at least one computer circuit board and is adapted to decipher language retrieved by said at least one microphone member and provide a translation in a pre-chosen language through text upon said liquid crystal display screen and audio through said at least one speaker member.

2. The multi-language translation converter of claim 1, further comprising a power source located within said interior volume of said main body and is electronically connected to said at least one microphone member, said at least one speaker member, and said at least one computer circuit board, and provides power thereto.

3. The multi-language translation converter of claim 2, wherein said power source is formed as a rechargeable battery member.

4. The multi-language translation converter of claim 2, wherein said power source is formed as an alternating current wire and plug having a transformer member electrically connected thereto and adapted to retrieve power from an external source and transform and provide pre-determined electrical power to said at least one microphone member, said at least one speaker member, and said at least one computer circuit board.

5. The multi-language translation converter of claim 1, wherein said liquid crystal display screen includes touch-screen technology.

6. The multi-language translation converter of claim 1, further comprising an on/off switch attached to said main body and is adapted to turn on and off power from said power source.

7. The multi-language translation converter of claim 1, further comprising a volume adjustment potentiometer attached to said main body and is adapted to adjust the volume of sound from said speaker member.

8. The multi-language translation converter of claim 1, wherein said at least one computer circuit board further comprises software encoded thereon adapted to provide menu options upon said liquid crystal display screen for allowing a user to choose a specific language to translate to emit upon said liquid crystal display screen and through said at least one speaker member.

9. The multi-language translation converter of claim 1, wherein said multi-language translation software is adapted allow a user to determine a desired decibel level audio from said at least one speaker member is emitted therefrom and then automatically control the volume of said audio emitted therefrom.

10. The multi-language translation converter of claim 1, wherein said multi-language translation software is adapted to provide text upon said liquid crystal display screen that includes information on the language detected and the language translated into.

11. The multi-language translation converter of claim 1, further comprising a language selector button attached to said main body and is electronically connected to said at least one microphone member, said at least one speaker member, and said at least one computer circuit board, and is adapted to allow a user to choose a language said multi-language translation software will translate that is retrieved by said at least one speaker member.

12. The multi-language translation converter of claim 1, wherein there are two spaced speaker members.

13. The multi-language translation converter of claim 1, wherein there are two spaced microphone members.

14. The multi-language translation converter of claim 1, wherein said plurality of walls of said main body are formed from a rigid plastic material.
